(19) United States
(12) Patent Application Publication
(10) Pub. No.: US 2024/0214328 A1
(43) Pub. Date: Jun. 27, 2024

(54) METHOD FOR DISPLAYING VIRTUAL RESOURCE INFORMATION AND ELECTRONIC DEVICE

(71) Applicant: BEIJING DAJIA INTERNET INFORMATION TECHNOLOGY CO., LTD., Beijing (CN)

(72) Inventors: Dongquan YUE, Beijing (CN); Wusheng LI, Beijing (CN)

(21) Appl. No.: 18/488,355

(22) Filed: Oct. 17, 2023

(30) Foreign Application Priority Data
Dec. 24, 2022 (CN) 202211668733.3

(51) Int. Cl. H04L 47/70; H04L 47/80

(52) U.S. Cl. CPC H04L 47/821; H04L 47/808

(57) ABSTRACT

A method for displaying virtual resource information includes: displaying a virtual resource package receivable by a user account and a reservation option, wherein the reservation option is switchable between a selected state and an unselected state, and an activity prompter for the virtual resource package is enabled in response to the reservation option being in the selected state; and outputting prompt information in response to the reservation option being in the selected state and a target activity being started, wherein the prompt information is configured to prompt the user account to use the virtual resource package, and the target activity is at least one of a plurality of activities that allow use of the virtual resource package.

### CROSS-REFERENCE TO RELATED APPLICATION

This application is based on and claims priority to Chinese Patent Application No. 202211668733.3, filed on Dec. 24, 2022, the disclosure of which is herein incorporated by reference in its entirety.

### TECHNICAL FIELD

The present disclosure relates to the field of computer technologies, and in particular, relates to a method for displaying virtual resource information and an electronic device.

### BACKGROUND

With the development of the computer technologies, interactions between user accounts in a virtual space can be increased by providing virtual resource packages to the user accounts.

In some practices, the number of virtual resources corresponding to the virtual resource packages or receiving prompts are displayed in covers of the virtual resource packages to guide the user accounts to receive the virtual resource packages.

### SUMMARY

Embodiments of the present disclosure provide a method for displaying virtual resource information and an electronic device.

According to one aspect of the embodiments of the present disclosure, a method for displaying virtual resource information is provided.

The method includes: displaying, in response to a trigger operation for acquiring a virtual resource package, the virtual resource package receivable by a user account and a reservation option, wherein the virtual resource package includes a predetermined number of virtual resources, and the reservation option is configured to reserve activities that allow use of the virtual resource package, and switchable between a selected state and an unselected state, and an activity prompter for the virtual resource package is enabled in response to the reservation option being in the selected state; and outputting prompt information in response to the reservation option being in the selected state and a target activity being started, wherein the prompt information is configured to prompt the user account to use the virtual resource package, and the target activity is at least one of a plurality of activities that allow the use of the virtual resource package.

According to another aspect of the embodiments of the present disclosure, an electronic device is provided.

The electronic device includes: a processor; and a memory storing one or more instructions executable by the processor.

The processor, when loading and executing the one or more instructions, is caused to: display, in response to a trigger operation for acquiring a virtual resource package, the virtual resource package receivable by a user account and a reservation option, wherein the virtual resource package includes a predetermined number of virtual resources, and the reservation option is configured to reserve activities that allow use of the virtual resource package, and is switchable between a selected state and an unselected state, and an activity prompter for the virtual resource package is enabled in response to the reservation option being in the selected state; and output prompt information in response to the reservation option being in the selected state and a target activity being started, wherein the prompt information is configured to prompt the user account to use the virtual resource package, and the target activity is at least one of a plurality of activities that allow the use of the virtual resource package.

According to still another aspect of the embodiments of the present disclosure, a computer-readable storage medium storing one or more instructions therein is provided.

The one or more instructions, when loaded and executed by a processor of an electronic device, cause the electronic device to: display, in response to a trigger operation for acquiring a virtual resource package, the virtual resource package receivable by a user account and a reservation option, wherein the virtual resource package includes a predetermined number of virtual resources, and the reservation option is configured to reserve activities that allow use of the virtual resource package, and is switchable between a selected state and an unselected state, and an activity prompter for the virtual resource package is enabled in response to the reservation option being in the selected state; and output prompt information in response to the reservation option being in the selected state and a target activity being started, wherein the prompt information is configured to prompt the user account to use the virtual resource package, and the target activity is at least one of a plurality of activities that allow the use of the virtual resource package.

### BRIEF DESCRIPTION OF DRAWINGS

FIG. 1 is a schematic diagram of an application environment of a method for displaying virtual resource information according to some embodiments of the present disclosure;

FIG. 2 is a flowchart of a method for displaying virtual resource information according to some embodiments of the present disclosure;

FIG. 3 is a schematic diagram of a first page according to some embodiments of the present disclosure;

FIG. 4 is a schematic diagram of a second page according to some embodiments of the present disclosure;

FIG. 5 is a flowchart of a method for determining a state of a first reservation option according to some embodiments of the present disclosure;

FIG. 6 is a schematic diagram of another first page according to some embodiments of the present disclosure;

FIG. 7 is a schematic diagram of another second page according to some embodiments of the present disclosure;

FIG. 8 is a schematic diagram of reservation prompt information according to some embodiments of the present disclosure;

FIG. 9 is a schematic diagram of an activity list according to some embodiments of the present disclosure;

FIG. 10 is a schematic diagram of another second page according to some embodiments of the present disclosure;

FIG. 11 is a block diagram of an apparatus for displaying virtual resource information according to some embodiments of the present disclosure; and

FIG. 12 is a block diagram of an electronic device according to some embodiments of the present disclosure.

### DETAILED DESCRIPTION

It should be noted that the user information (including but not limited to information of a user device, personal information of a user, and the like) and data (including but not limited to data for displaying, data for analyzing, and the like) involved in the present disclosure are information and data authorized by the user or sufficiently authorized by the parties.

In some online Applications, virtual resources are provided to the user accounts to increase the probability that the user accounts interact each other in a virtual space. In some practices, the user account can receive the virtual resource package in time, but there are situations where the user does not use the virtual resource package in time or fails to quickly determine a manner of using the virtual resource package, which results in a lower utilization rate of the virtual resource package.

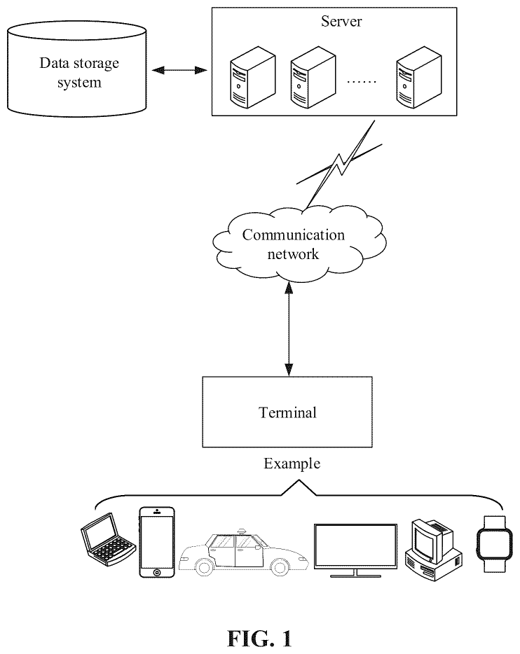

The method for displaying the virtual resource information in the embodiments of the present disclosure may be applicable to the application environment shown in FIG. 1. The application environment includes a terminal and a server, and the terminal is communicated with the server via a communication network. In the embodiments of the present disclosure, the user receives the virtual resource package provided by the server through the user account logged in to the terminal, and the terminal displays the virtual resource package of the user account and a reservation option upon receipt of the virtual resource package by the user account. The reservation option is switchable between a selected state and an unselected state, and an activity prompter for the virtual resource package is enabled in response to the reservation option being in the selected state. Prompt information is output in response to the reservation option being in the selected state and a target activity being started. The prompt information is configured to prompt the user account to use the virtual resource package, and the target activity is at least one of a plurality of activities that allow use of the virtual resource package.

The terminal includes, but is not limited to various electronic devices such as personal computers, laptops, smart mobile phones, tablets, Internet of things (IOT) devices, and portable wearable devices. The IoT devices include smart speakers, smart televisions, smart air conditioners, smart vehicle equipment, and the like. The portable wearable devices are smart watches, smart bracelets, head-mounted devices, and the like. The server is implemented by an independent server or a server cluster composed of multiple servers. The server includes a data storage system. The data storage system stores data required to be processed by the server, such as information corresponding to the virtual resource packages or information of the user accounts. In actual applications, the data storage system is integrated on the server, the cloud server, or other network servers.

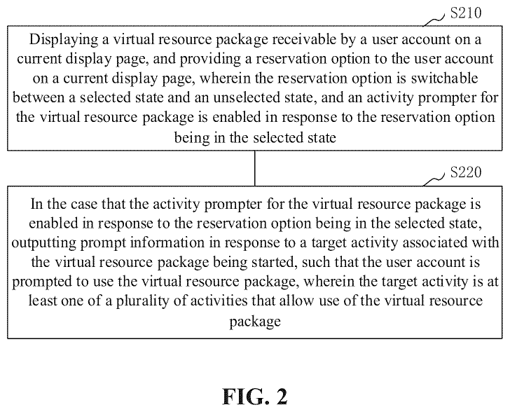

FIG. 2 is a flowchart of a method for displaying virtual resource information according to some embodiments of the present disclosure. As shown in FIG. 2, the method for displaying the virtual resource information is applicable to the terminal, and includes the following processes.

In S210, a virtual resource package receivable by a user account is displayed on a current display page, and a reservation option is provided to the user account on the current display page, wherein the reservation option is switchable between a selected state and an unselected state, and an activity prompter for the virtual resource package is enabled in response to the reservation option being in the selected state.

The virtual resource package is a package for exchanging resources in resource platform or exchanging for certain online activities, and includes a predetermined number of virtual resources that can be used in service activities or in a virtual space. The displayed virtual resource package is a virtual resource package currently received or previously received by the user account. The virtual resources in the virtual resource package are valid or are partially invalid. In some embodiments, the virtual resource is at least one of a red packet or a virtual prop. It should be noted that the embodiments of the present disclosure are described by taking the current display page providing the reservation option to the user account as an example. In some embodiments, S210 is not performed, and the virtual resource package receivable by the user account and the reservation option are displayed in other manners.

In the embodiments of the present disclosure, upon receipt of the virtual resource package by the user account, the terminal displays the virtual resource package receivable by the user account on the current display page. Illustratively, the terminal displays the virtual resource package on the current display page in response to a trigger operation for acquiring the virtual resource package by the user account and receipt of the virtual resource package by the user account. In some embodiments, the displaying of the virtual resource package receivable by the user account is triggered in other manners. Illustratively, the terminal displays the virtual resource package receivable by the user account in response to a trigger operation for viewing a receiving record of the virtual resource packages or detailed information of the virtual resource packages by the user account.

When the virtual resource package is displayed on the current display page, the reservation option for the virtual resource package is also provided to the user account on the current display page. That is, the reservation option is displayed on the current display page. The reservation option is configured to reserve activities that allow use of the virtual resource package, and the reservation option may be in the selected state or the unselected state.

In some embodiments, in the case that the reservation option is displayed on the current display page for the first time, the reservation option is in a predetermined state set by the user account or the terminal. For example, the predetermined state is the selected state, such that the user account does not need to check the reservation option to switch the predetermined option to the selected state each time the reservation option for the virtual resource package is displayed to the user account for the first time. In some embodiments, the predetermined state is the unselected state, such that the user account determines whether to switch the predetermined option to the selected state according to actual situations.

In S220, in the case that the activity prompter for the virtual resource package is enabled in response to the reservation option being in the selected state, prompt information is output in response to a target activity associated with the virtual resource package being started, such that the user account is prompted to use the virtual resource package, wherein the target activity is at least one of a plurality of activities that allow use of the virtual resource package. That is, the prompt information is output in response to the reservation option being in the selected state and the target activity being started, and the prompt information is configured to prompt the user account to use the virtual resource package.

In the embodiments of the present disclosure, the virtual resource package corresponds to a corresponding use range, and is allowed to be used in the corresponding use range. The use range of the virtual resource package includes the plurality of activities associated with the virtual resource package, and the virtual resource package is allowed to be used in the activities associated with the virtual resource package. In some embodiments, the activities that allow use of the virtual resource package include activities in the virtual space (for example, a live streaming room) or activities in a resource platform.

In the case that the reservation option is provided on the current display page, the user account selects or switches the state of the reservation option, such that the reservation option is in the selected state or the unselected state. In the case that the reservation option is in the selected state, the activity prompter for the virtual resource package is enabled. The activity prompter is configured to prompt the user account to participate in the activities associated with the virtual resource package and to use the virtual resource package. Thus, in the case that the target activity associated with the virtual resource package is started, the prompt information is output to prompt the user account to use the virtual resource package. In some embodiments, in addition to outputting the prompt information when the target activity is started, the terminal outputs the prompt information when the target activity is in progress.

In the above method for displaying the virtual resource information, the terminal displays the virtual resource package receivable by the user account, and provides the reservation option to the user account on the current display page. The reservation option is switchable between the selected state and the unselected state, and the activity prompter for the virtual resource package is enabled in response to the reservation option being in the selected state. Thus, the prompt information is output in response to the target activity associated with the virtual resource package being started to prompt the user account to use the virtual resource package. The target activity is at least one of the plurality of activities that allow use of the virtual resource package. In the embodiments of the present disclosure, as the reservation option is provided on the display page of the virtual resource package, and the activity prompter for the virtual resource package is enabled in response to the reservation option being in the selected state, the prompt information is output in response to the target activity that allow use of the virtual resource package being started to prompt the user account to use the virtual resource package, such that the target activity associated with the virtual resource package is reserved in time, and the user is prompted to use the virtual resource package in time at the start of the target activity. Thus, the missing of the use is avoided, a write-off rate of the virtual resource package is efficiently increased, and the utilization rate of the virtual resource package is improved.

In addition, by reserving the target activity associated with the virtual resource package in time, a rate of reserving the activities and a rate of participating the activities are improved, and an efficiency of using the resources in the platform is improved.

In some embodiments, the reservation option includes at least one of a first reservation option displayed on a first page and a second reservation option displayed on a second page.

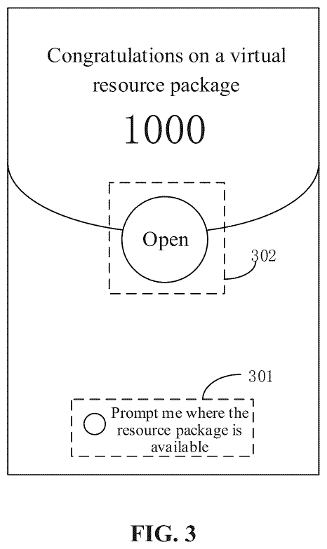

The first page is configured for receiving the virtual resource package, and is a receiving page of a virtual resource package. FIG. 3 shows an example of the first page. The first reservation option 301 is set or configured on the first page, and the number of virtual resources (1000 virtual resources in this example) in the virtual resource package is displayed on the first page.

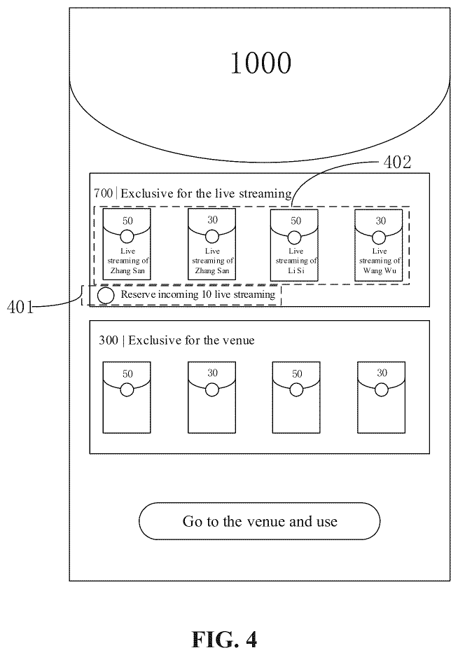

The second page is for displaying detailed information of the virtual resource package. FIG. 4 shows an example of the second page. The second reservation option 401 is set on the second page, and related information of the virtual resource package is displayed on the second page.

In some related technology, the user is guided to receive the virtual resource package and is notified the number of virtual resources in the virtual resource package through a display page of the virtual resource package. In the embodiments of the present disclosure, more functions are provided in one or more display pages of the virtual resource package. For example, the first reservation option is displayed on the first page, or the second reservation option is displayed on a second page, such that the user can receive the activity prompter for the target activity in time to avoid missing the activities or avoid missing the use of the virtual resource package. In addition, the first reservation option is provided on the receiving page of the virtual resource package, such that the user account is capable of triggering the activity prompter for the virtual resource package when receiving the virtual resource package. Thus, receiving the virtual resource package is associated with the use of the virtual resource package, such that the user can activate/trigger the activity prompter for the virtual resource package in time when receiving the virtual resource package, and the reservation efficiency is improved. Alternatively or additionally, the second reservation option is displayed on the second page or the page having detailed information of the virtual resource package, such that the user account can trigger the activity prompter for the virtual resource package when viewing the detailed information page, which avoids the switching from the detail information page to the receiving page of a virtual resource package and improves the reservation efficiency.

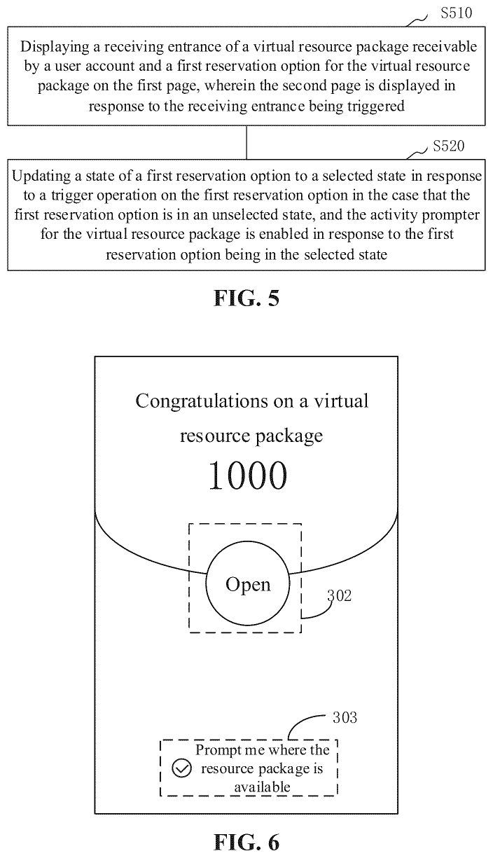

In some embodiments, in the case that the reservation option includes the first reservation option, the method for displaying virtual resource information may include the steps as shown in FIG. 5. The displaying the virtual resource package receivable by the user account and providing the reservation option to the user account on the current display page in S210 include the following processes.

In S510, a receiving entrance of the virtual resource package receivable by the user account and the first reservation option for the virtual resource package are displayed on the first page, wherein the second page is displayed in response to the receiving entrance being triggered.

In the embodiments of the present disclosure, the receiving entrance of the virtual resource package receivable by the user account is displayed on the first page. For example, the receiving entrance is the control 302 shown in FIG. 3. The second page corresponding to the virtual resource package is displayed by triggering the receiving entrance (e.g., the control 302). In addition, the first reservation option for the virtual resource package is displayed on the first page.

In S520, a state of the first reservation option is updated to the selected state in response to a trigger operation on the first reservation option in the case that the first reservation option is in the unselected state, and the activity prompter for the virtual resource package is enabled in response to the first reservation option being in the selected state.

In the case that the first reservation option on the first page is in the unselected state, for example, the terminal defaults that the first reservation option is in the unselected state in the first display of the first page, the user performs the trigger operation on the first reservation option, and the trigger operation is configured to trigger the first reservation option. In the illustrated example in FIG. 3, the first reservation option 301 includes a check box and text “prompt me where the resource package is available”. The check box is shown to be unchecked, which indicate that the first reservation option is in the unselected state.

The terminal updates the state of the first reservation option to the selected state in response to the trigger operation on the first reservation option, and thus the activity prompter for the virtual resource package is enabled. Illustratively, in the case that the user account triggers the first reservation option 301 in the FIG. 3 (e.g., the user checked the box for the first reservation option), the terminal switches the state of the first reservation option to the state of the first reservation option 303 shown in FIG. 6 where the box for the first reservation option is checked, and the user determines, based on the first reservation option 303, that the activity prompter for the virtual resource package is enabled.

In the embodiments of the present disclosure, in the case that the first reservation option is in the unselected state, the activity prompter for the activities associated with the virtual resource package is enabled in response to the trigger operation on the first reservation option on the first page, such that the reservation efficiency of the activities associated with the virtual resource package is efficiently improved.

In some embodiments, the method further includes the following processes upon S510.

The second page is displayed in response to a trigger operation on the receiving entrance on the first page, and at least one target activity associated with the virtual resource package and the second reservation option are displayed on the second page.

The term “at least one” refers to one or more. The second page is displayed in response to the trigger operation on the receiving entrance on the first page, and the target activity associated with the virtual resource package and the second reservation option are displayed on the second page. The second reservation option is initially in the selected state, that is, an initial state of the second reservation option is the selected state, in the case that the first reservation option is in the selected state prior to the trigger operation on the receiving entrance. The second reservation option is initially in the unselected state in the case that the first reservation option is in the unselected state prior to the trigger operation on the receiving entrance. The activity prompter for the virtual resource package is enabled in response to the second reservation option being in the selected state. An initial state is a state of the second reservation option on the second page in displaying the second page, that is, a default state of the second reservation option in displaying the second reservation option on the second page.

In the embodiments of the present disclosure, the trigger operation is performed on the receiving entrance on the first page to jump to the second page, and one or more target activities associated with the virtual resource package and the second reservation option for the target activities are displayed on the second page. The target activity is an activity that allows use of the virtual resource package.

In some embodiments, the state of the second reservation option on the second page is the same as the state of the first reservation option on the first page. Prior to the trigger operation on the receiving entrance, the second reservation option is in the selected state in the case that the first reservation option is in the selected state and the terminal displays the second page and displays the second reservation option on the second page. Prior to the trigger operation on the receiving entrance, the second reservation option is in the unselected state in the case that the first reservation option is in the unselected state and the terminal displays the second page and displays the second reservation option on the second page.

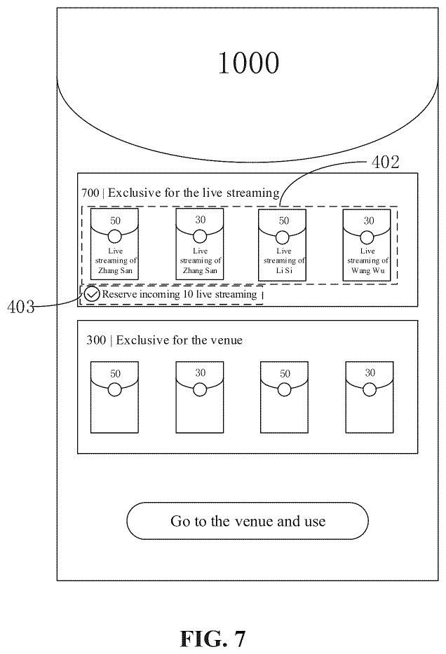

Illustratively, in the first page shown in FIG. 3, in the case that the first reservation option 301 is in the unselected state, the terminal displays the second page shown in FIG. 4 in response to the trigger operation on the receiving entrance 302, the second page includes a plurality of target activities 402 associated with the virtual resource package, and the second reservation option 401 is in the unselected state. Illustratively, in the first page shown in FIG. 6, in the case that the first reservation option 303 is in the selected state, the terminal displays the second page shown in FIG. 7 in response to the trigger operation on the receiving entrance 302, and the second reservation option 403 on the second page is in the selected state.

In the embodiments of the present disclosure, the trigger operation is performed on the receiving entrance to jump to the page of the detailed information of the virtual resource package, and the target activity associated with the virtual resource package and the second reservation option are provided on the page of the detailed information. That is, the target activity and the second reservation option are provided on the page of the detailed information, such that the terminal displays the reservation state of the target activity to the user in the case that the user views the detailed information of the target activity associated with the virtual resource package, and the one-tap reservation for the target activities associated with the virtual resource package is achieved in the case that the first reservation option is in the selected state. In addition, the state of the second reservation option is the same as the state of the first reservation option in changing from the receiving page to the page of detailed information, such that the user does not need to repeatedly switch the state of the reservation option, and the reservation efficiency of the target activity is improved.

In some embodiments, the method further includes the following processes upon displaying the second page.

In the case that the second reservation option is in the selected state, the state of the second reservation option is updated to the unselected state in response to the trigger operation on the second reservation option.

An activity prompter for at least one target activity associated with the virtual resource package is not enabled in response to the second reservation option being in the unselected state. That is, the activity prompter for the target activity associated with the virtual resource package is disabled in response to the second reservation option being switched from the selected state to the unselected state.

Upon displaying of the second reservation option on the second page, the user triggers the trigger operation for the second reservation option in the case that the second reservation option is in the unselected state and the activity prompter for the plurality of target activities associated with the virtual resource package are enabled. In the case that the second reservation option is in the selected state and the trigger operation for the second reservation option is performed, the terminal updates the state of the second reservation option to the unselected state and disables the activity prompter for at least one target activity associated with the virtual resource package. For example, the terminal displays the state of the second reservation option 401 shown in FIG. 4 in the case that the state of the second reservation option on the second page is the state of the second reservation option 403 shown in FIG. 7 and the trigger operation for the second reservation option 403 is performed.

In the embodiments of the present disclosure, in the case that the second reservation option is in the selected state, the state of the second reservation option is updated to the unselected state in response to the trigger operation on the second reservation option, such that the one-tap disablement on the activity prompter for the target activities is achieved in the page of the detailed information of the virtual resource package, the disablement reservation efficiency of the target activities associated with the virtual resource package is improved, and one-by-one tap operations are not needed. Compared with complex information in the page of the detailed information in some practices, the second reservation option for the target activity is provided in the embodiments of the present disclosure, such that the user operation is efficiently simplified, and the efficiency of acquiring the information of the user is improved.

In some embodiments, in the case that the second reservation option is in the unselected state, the state of the second reservation option is updated to the selected state in response to the trigger operation on the second reservation option. Illustratively, in the case that the state of the second reservation option on the second page is the state of the second reservation option 401 shown in FIG. 4, the terminal displays the state of the second reservation option 403 shown in FIG. 7 in response to the trigger operation on the second reservation option 403.

On this basis, the one-tap reservation for the activity prompter for the target activities is achieved in the page of the detailed information of the virtual resource package, such that the reservation efficiency of the target activities associated with the virtual resource package is improved, and one-by-one tap operations are not needed.

In some embodiments, the method further includes the following processes upon displaying the second page.

The reservation prompt information for the virtual resource package is displayed in response to a trigger operation for exiting the second page in the case that the second reservation option is in the unselected state, and the reservation prompt information is configured to prompt the user account to enable an activity prompter for at least one target activity associated with the virtual resource package. The trigger operation for exiting the second page is the exit operation on the second page.

In some application scenarios, upon displaying of the target activity associated with the virtual resource package and the second reservation option on the second page, the user receives the virtual resource package at this time and does not reserve the target activity in the case that the user does not check the second reservation option but nevertheless performs the trigger operation for exiting the second page. In these scenarios, there may be a case that the virtual resource package is not used in time, that is, the target activity in progress is not participated in time and the virtual resource package is invalid.

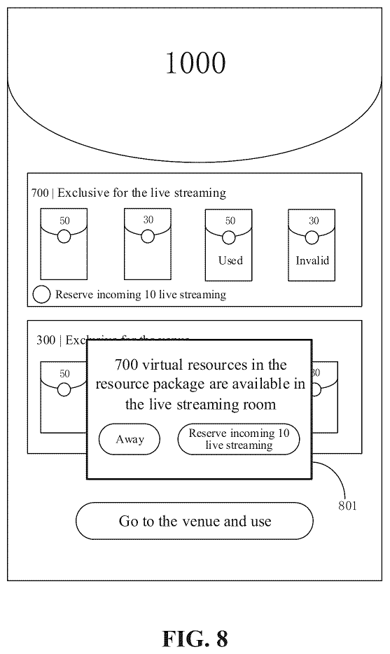

In the case that the second reservation option is in the unselected state, the terminal is configured to display the reservation prompt information for the virtual resource package in response to a trigger operation for exiting the second page, such that the user account is prompted to enable the display of the activity prompter for at least one target activity associated with the virtual resource package. Illustratively, in the case that the trigger operation for exiting the second page is performed, the terminal displays the reservation prompt information. In the example shown in FIG. 8, the reservation prompt information 801 is shown in a pop up window on the second page to prompt the user account about the target activities. In this way, the user is reminded of reserving the incoming live streaming.

In the embodiments of the present disclosure, the reservation prompt information is output in the case that the trigger operation for exiting the second page is performed and the second reservation option is in the unselected state, such that the user is prompted to enable the activity prompter for the target activity in time. Thus, missing of the use occasion of the virtual resource package by the user is reduced, reservation of the target activity is improved, and an efficiency of using the virtual resources and other resources in the platform is improved.

In some embodiments, the method further includes the following processes upon displaying of the reservation prompt information for the virtual resource package.

The state of the second reservation option is updated to the selected state in response to a reservation determine operation on the reservation prompt information by the user account, and an activity list is displayed.

The activity list includes at least one target activity associated with the virtual resource package and an activity schedule corresponding to the target activities, and the activity prompter for the target activity is enabled. That is, the target activities in the displayed activity list are activities with the enabled activity prompter.

In the embodiments of the present disclosure, in the case that the reservation prompt information for the virtual resource package is displayed, and the terminal detects the reservation determine operation on the reservation prompt information by the user account, the terminal updates the state of the second reservation option to the selected state, and displays the activity list corresponding to the activities with the enabled activity prompter. In one example shown in FIG. 8, the reservation determine operation on the reservation prompt information is a tap on the button of a “reserve incoming 10 live streaming”. The activity list includes at least one target activity associated with the virtual resource package and an activity schedule corresponding to the at least one target activity.

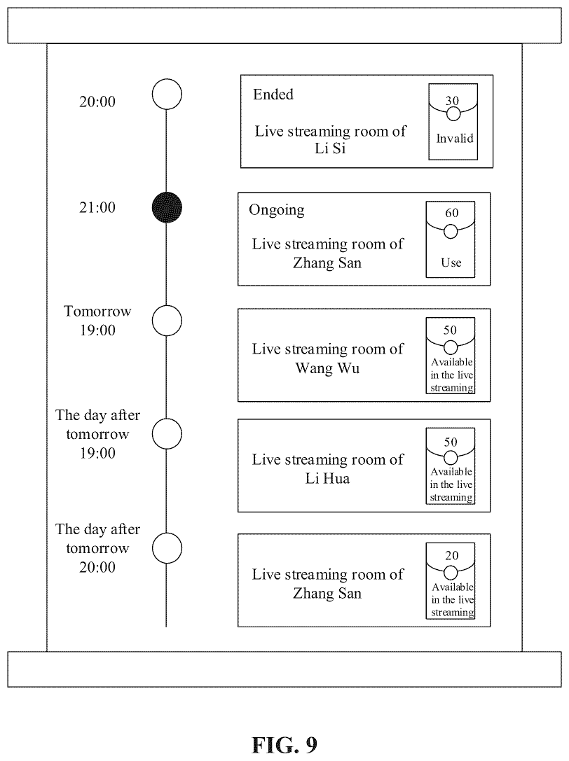

In some embodiments, the activity schedule includes a start time of the target activity, an activity state of the target activity (for example, ongoing, ended, or about to start), and the resource sub-packages allowed to be used in the target activity. FIG. 9 shows an example of the activity schedule. FIG. 9 shows five live streaming rooms, and shows a start time, and an activity state corresponding to each live streaming room.

In the embodiments of the present disclosure, upon the reservation operation on the reservation prompt information by the user, the terminal updates the state of the second reservation option to the selected state, and displays the activity list corresponding to the activities with the enabled activity prompter, such that the reservation state of the target activity is clearly displayed, and the efficiency of acquiring the reservation information associated with the target activity by the user is improved.

In some embodiments, virtual resource package includes a plurality of resource sub-packages, and each resource sub-package has allowed scenario or activity. The method further includes the following processes.

Types of usage scenarios corresponding to the plurality of resource sub-packages are determined.

In some embodiments, the types of usage scenarios are types of usage scenarios corresponding to the usage scenarios in which the resource sub-packages are allowed to be used. In some embodiments, the types of usage scenarios include at least one of a live streaming, a recorded broadcast, and a predetermined venue.

In the embodiments of the present disclosure, in the case that the user account receives the virtual resource package, the types of usage scenarios corresponding to the plurality of resource sub-packages are determined.

Thus, displaying the virtual resource package receivable by the user account and providing the reservation option to the user account on the current display page in S210 include the following processes.

The plurality of resource sub-packages in the virtual resource package receivable by the user account and the types of the usage scenarios corresponding to the plurality of resource sub-packages are displayed on the second page, and the second reservation option is provided to the user account for the resource sub-package of the target usage scenario. That is, the plurality of resource sub-packages, the types of the usage scenarios corresponding to the plurality of resource sub-packages, and the second reservation option are displayed on the second page, and the second reservation option corresponds to the target usage scenario.

A type of the target usage scenario includes a type of a live streaming scenario, and an activity prompter for the resource sub-package corresponding to the type of the live streaming scenario is enabled in response to the second reservation option being in the selected state, such that the prompt information is output in response to at least one live streaming activity associated with the resource sub-package corresponding to the type of the live streaming scenario being started. The prompt information is configured to prompt the user account to use the virtual resource package.

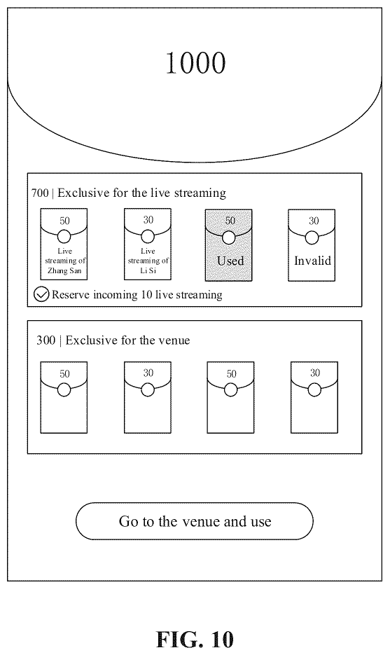

In the embodiments of the present disclosure, the plurality of resource sub-packages in the virtual resource package receivable by the user account are displayed on the second page, and the types of the usage scenarios corresponding to the plurality of resource sub-packages are displayed on the second page. Illustratively, as shown in FIG. 10, a plurality of resource sub-packages corresponding to the type of the live streaming scenario (that is, 700 resources exclusive for the live streaming shown in FIG. 10) and a plurality of resource sub-packages corresponding to the type of the predetermined venue scenario (that is, 300 resources exclusive for the venue shown in FIG. 10) are displayed. In addition, in some embodiments, as shown in FIG. 10, the state of the resource package corresponding to each resource sub-package is displayed. In some embodiments. the state of the resource package includes at least one of a valid state, an invalid state, and a used state as illustrated for the live streaming in FIG. 10.

In addition, in a target usage scenario, for the resource sub-packages corresponding to the type of the live streaming scenario, the terminal further provides the second reservation option to the user account, and the activity prompter for the resource sub-packages corresponding to the type of the live streaming scenario is enabled in response to the second reservation option being in the selected state. In the case that at least one live streaming activity associated with the resource sub-package corresponding to the type of the live streaming scenario is started, the prompt information is output to prompt the user account to use the virtual resource package.

In the embodiments of the present disclosure, the resource sub-packages corresponding to different types of usage scenarios are displayed separately, such that the usage scenarios of the resource sub-packages are displayed to the user for realizing the uses of the resource sub-packages in time. In addition, for the resource sub-packages corresponding to the type of the live streaming scenario, the second reservation option is provided, such that the user is capable of participating the live streaming activity and using the corresponding resource sub-packages, and the utilization of the resource sub-packages is improved.

Based on the same concept, the embodiments of the present disclosure further provide an apparatus for displaying virtual resource information that is applicable to performing the above method for displaying virtual resource information.

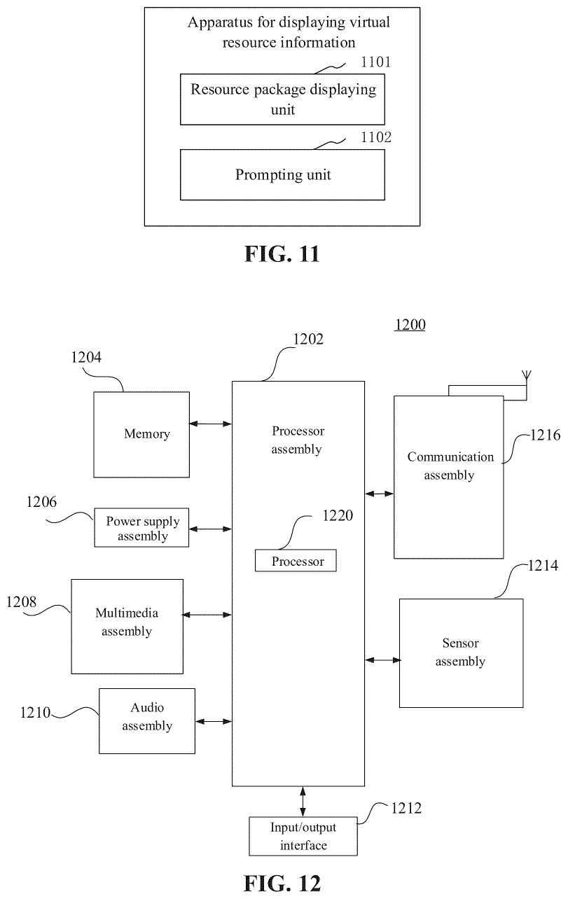

FIG. 11 is a block diagram of an apparatus for displaying virtual resource information according to some embodiments of the present disclosure. As shown in FIG. 11, the apparatus includes a resource package displaying unit 1101 and a prompting unit 1102.

The resource package displaying unit 1101 is configured to display a virtual resource package receivable by a user account and a reservation option, wherein the reservation option is switchable between a selected state and an unselected state, wherein an activity prompter for the virtual resource package is enabled in response to the reservation option being in the selected state.

The prompting unit 1102 is configured to output prompt information in response to the reservation option being in the selected state and a target activity being started, wherein the prompt information is configured to prompt the user account to use the virtual resource package, and the target activity is at least one of a plurality of activities that allow use of the virtual resource package.

In some embodiments, the reservation option includes at least one of a first reservation option displayed on a first page and a second reservation option displayed on a second page, wherein
the first page is for receiving the virtual resource package, and
the second page is for displaying detailed information of the virtual resource package.

In some embodiments, the reservation option includes the first reservation option, and the resource package displaying unit 1101 is configured to:
display a receiving entrance of the virtual resource package and the first reservation option on the first page, wherein the second page is displayed in response to the receiving entrance being triggered; and
update a state of the first reservation option to the selected state in response to a trigger operation on the first reservation option in the case that the first reservation option is in the unselected state.

In some embodiments, the resource package displaying unit 1101 is configured to:
display the second page in response to a trigger operation on the receiving entrance, and display the target activity associated with the virtual resource package and the second reservation option on the second page, wherein
the second reservation option is initially in the selected state in the case that the first reservation option is in the selected state prior to the trigger operation on the receiving entrance, and
the second reservation option is initially in the unselected state in the case that the first reservation option is in the unselected state prior to the trigger operation on the receiving entrance.

In some embodiments, the apparatus further includes:
a state updating unit, configured to update a state of the second reservation option to the unselected state in response to a trigger operation on the second reservation option in the case that the second reservation option is in the selected state, wherein
an activity prompter for the target activity associated with the virtual resource package is not enabled in response to the second reservation option being in the unselected state.

In some embodiments, the apparatus further includes:
a reservation prompt information displaying unit, configured to display reservation prompt information for the virtual resource package in response to an exit operation on the second page in the case that the second reservation option is in the unselected state, wherein
the reservation prompt information is configured to prompt the user account to enable an activity prompter for the target activity.

In some embodiments, the apparatus further includes:
an activity list displaying unit, configured to update a state of the second reservation option to the selected state in response to a reservation determine operation on the reservation prompt information, and display an activity list, wherein
the activity list includes the target activity and a corresponding activity schedule, and the activity prompter for the target activity is enabled.

In some embodiments, the virtual resource package includes a plurality of resource sub-packages, and the apparatus further includes:
a scenario type determining unit, configured to determine types of usage scenarios corresponding to the plurality of resource sub-packages; and
the resource package displaying unit 1101 is configured to:
display the plurality of resource sub-packages, the types of the usage scenarios corresponding to the plurality of resource sub-packages, and the second reservation option on the second page, wherein the second reservation option corresponds to a target usage scenario, a type of the target usage scenario includes a type of a live streaming scenario, and an activity prompter for the resource sub-package corresponding to the type of the live streaming scenario is enabled in response to the second reservation option being in the selected state; and
output the prompt information in response to a live streaming activity associated with the resource sub-package corresponding to the type of the live streaming scenario being started.

The modules in the above apparatus for displaying the virtual resource information are all or partially implemented by the software, hardware, or combinations thereof. The above modules can be embedded in the processor in the computer device in the hardware form or independently, and can also be stored in the memory of the computer device in the software form, such that the processor can call and perform the corresponding operations of the above modules.

FIG. 12 is a block diagram of an electronic device 1200 according to some embodiments of the present disclosure. The electronic device 1200 can be a mobile phone, a computer, a digital broadcast terminal, a messaging device, a game console, a tablet device, a medical device, a fitness device, a personal digital assistant, and the like.

Referring to FIG. 12, the electronic device 1200 includes one or more of a processor assembly 1202, a memory 1204, a power supply assembly 1206, a multimedia assembly 1208, an audio assembly 1210, an input/output (I/O) interface 1212, a sensor assembly 1214, and a communication assembly 1216.

Typically, the processor assembly 1202 controls the operation of the electronic device 1200, for example, operations associated with display, telephone calls, data communications, camera operations, and recording operations. The processor assembly 1202 includes one or more processors 1220 to execute instructions to perform all or part of the processes in the above method. In addition, the processor assembly 1202 includes one or more modules to facilitate the interaction between the processor assembly 1202 and other assemblies. For example, the processor assembly 1202 includes a multimedia module to facilitate interaction between the multimedia assembly 1208 and the processor assembly 1202.

The memory 1204 is configured to store various types of data to support operation on electronic devices 1200. Examples of the data include instructions for any application or method operated on the electronic device 1200, contact data, phone book data, messages, pictures, videos, and the. The memory 1204 is implemented by any type of volatile or non-volatile memory or combinations thereof, for example, a static random access memory (SRAM), an electrically crasable programmable read-only memory (EEPROM), an erasable programmable read-only memory (EPROM), a programmable read-only memory (PROM), a read-only memory (ROM), a magnetic memory, a flash memory, a disk, an optical disc, or a graphene memory.

The power supply assembly 1206 supplies power to various assemblies of electronic device 1200. The power supply assembly 1206 includes a power management system, one or more power supplies, and other assemblies associated with generating, managing, and distributing power for electronic devices 1200.

The multimedia assembly 1208 includes a screen providing an output interface between the electronic device 1200 and the user. In some embodiments, the screen includes a liquid crystal display (LCD) and a touch panel (TP). In the case that the screen includes a touch panel, the screen is a touch screen to receive input signals from the user. The touch panel includes one or more touch sensors to sense the touch, the swiping, and the gestures on the touch panel. The touch sensor senses the boundaries of the touch or the swiping, and detects the duration and pressure associated with the touch or the swiping. In some embodiments, the multimedia assembly 1208 includes a front camera and/or a rear camera. When the electronic device 1200 is in operating mode, such as a shooting mode or a video mode, the front camera and/or rear camera is capable of receiving external multimedia data. Each of the front camera and the rear camera is a fixed optical lens system or has a focal length and optical zoom capabilities.

The audio assembly 1210 is configured to output and/or input audio signals. For example, the audio assembly 1210 includes the microphone (MIC). In the case that the electronic device 1200 is in the operational mode, such as the call mode, the recording mode, and the speech recognition mode, the microphone is configured to receive external audio signals. The received audio signal is further stored in the memory 1204 or transmitted by the communication assembly 1216. In some embodiments, the audio assembly 1210 also includes a speaker for the output of the audio signal.

The I/O interface 1212 provides an interface between the processor assembly 1202 and the peripheral interface module, and the peripheral interface module may be a keyboard or keypad, a click wheel, a button, and the like. The button includes, but is not limited to: a home button, a volume button, a start button, and a lock button.

The sensor assembly 1214 includes one or more sensors for providing a condition assessment of various aspects of the electronic device 1200. For example, the sensor assembly 1214 detects the on/off state of the electronic device 1200, the relative positions of the assemblies. For example, the assembly is the display and keypad of the electronic device 1200. The sensor assembly 1214 also detects the position change of the electronic device 1200 or assemblies of the electronic device 1200, the presence or absence of contact between the user and the electronic device 1200, the orientation or acceleration/deceleration of the device 1200, and the temperature change of the electronic device 1200. The sensor assembly 1214 includes a proximity sensor configured to detect the presence of nearby objects in the absence of any physical contact. The sensor assembly 1214 also includes an optical sensor, such as a CMOS or CCD image sensor used in imaging. In some embodiments, the sensor assembly 1214 also includes an acceleration sensor, a gyroscope sensor, a magnetic sensor, a pressure sensor, or a temperature sensor.

The communication assembly 1216 is configured to facilitate wired or wireless communication between the electronic device 1200 and other devices. The electronic device 1200 accesses wireless networks based on communication standards, such as Wi-Fi, carrier networks (such as 2G, 3G, 4G, or 5G), or combinations thereof. In some embodiments, the communication assembly 1216 receives broadcast signals or broadcast-related information from an external broadcast management system through the broadcast channel. In some embodiments, the communication assembly 1216 also includes a near-field communication (NFC) module to facilitate short-range communication. For example, the NFC module is implemented based on a radio frequency identification (RFID) technology, an infrared data association (IrDA) technology, an ultra-wideband (UWB) technology, a Bluetooth (BT) technology, and other technologies.

In some embodiments, the electronic device 1200 is implemented by one or more of an application specific integrated circuit (ASICS), a digital signal processor (DSPS), a digital signal processing device (DSPD), a programmable logic device (PLDS), a field programmable gate array (FPGA), a controller, a microcontroller, a microprocessor, or other electronic components. The electronic device 1200 is configured to perform the method for displaying the virtual resource information in the above method embodiments.

In some embodiments, a computer-readable storage medium including instructions is also provided, for example, a memory 1204 including instructions. The instructions, when executed by the processor 1220 of the electronic device 1200, cause the electronic device 1200 to perform the method for displaying the virtual resource information in the above method embodiments. For example, the computer-readable storage medium is a ROM, a random access memory (RAM), a CD-ROM, a magnetic tape, a floppy disk, and an optical data storage device.

In some embodiment, a computer program product is also provided. The computer program product includes instructions. The instructions, when executed by the processor 1220 of the electronic device 1200, cause the electronic device 1200 to perform the method for displaying the virtual resource information in the above method embodiments.

It should be noted that the above descriptions based on the method embodiments of the apparatus, the electronic device, the computer-readable storage media, the computer program products also include other embodiments, and the specific implementations may be referred to the description of the relevant method embodiments, which are not detailed herein.

All the embodiments of the present disclosure may be independently practiced, or practiced in combination with other embodiments, which are all considered as falling within the protection scope of the present disclosure.

What is claimed is:

1. A method for displaying virtual resource information, comprising:
displaying, in response to a trigger operation for acquiring a virtual resource package, the virtual resource package receivable by a user account and a reservation option, wherein the virtual resource package includes a predetermined number of virtual resources, and the reservation option is configured to reserve activities that allow use of the virtual resource package, and switchable between a selected state and an unselected state, and an activity prompter for the virtual resource package is enabled in response to the reservation option being in the selected state; and
outputting prompt information in response to the reservation option being in the selected state and a target activity being started, wherein the prompt information is configured to prompt the user account to use the virtual resource package, and the target activity is at least one of a plurality of activities that allow the use of the virtual resource package.

2. The method according to claim 1, wherein the reservation option comprises at least one of a first reservation option displayed on a first page and a second reservation option displayed on a second page, wherein the first page is for receiving the virtual resource package, and the second page is for displaying detailed information of the virtual resource package.

3. The method according to claim 2, wherein the reservation option comprises the first reservation option; and said displaying the virtual resource package receivable by the user account and the reservation option comprises:
displaying a receiving entrance of the virtual resource package and the first reservation option on the first page, wherein the second page is displayed in response to the receiving entrance being triggered; and
updating a state of the first reservation option to the selected state in response to a trigger operation on the first reservation option in the case that the first reservation option is in the unselected state.

4. The method according to claim 3, further comprising:
displaying the second page in response to a trigger operation on the receiving entrance, and displaying the target activity associated with the virtual resource package and the second reservation option on the second page, wherein the second reservation option is initially in the selected state in the case that the first reservation option is in the selected state prior to the trigger operation on the receiving entrance, and the second reservation option is initially the unselected state in the case that the first reservation option is in the unselected state prior to the trigger operation on the receiving entrance.

5. The method according to claim 4, further comprising:
updating a state of the second reservation option to the unselected state in response to a trigger operation on the second reservation option in the case that the second reservation option is in the selected state, and an activity prompter for the target activity associated with the virtual resource package is not enabled in response to the second reservation option being in the unselected state.

6. The method according to claim 4, further comprising:
displaying reservation prompt information for the virtual resource package in response to an exit operation on the second page in the case that the second reservation option is in the unselected state, wherein the reservation prompt information is configured to prompt the user account to enable an activity prompter for the target activity.

7. The method according to claim 6, further comprising:
updating a state of the second reservation option to the selected state in response to a reservation determine operation on the reservation prompt information, and displaying an activity list, wherein the activity list comprises the target activity and a corresponding activity schedule, and the activity prompter for the target activity is enabled.

8. The method according to claim 2, wherein
the virtual resource package comprises a plurality of resource sub-packages; and
the method further comprises:
determining types of usage scenarios corresponding to the plurality of resource sub-packages;
and displaying the virtual resource package receivable by the user account and the reservation option comprises:
displaying the plurality of resource sub-packages, the types of the usage scenarios corresponding to the plurality of resource sub-packages, and the second reservation option on the second page, wherein the second reservation option corresponds to a target usage scenario, a type of the target usage scenario comprises a type of a live streaming scenario, and an activity prompter for the resource sub-package corresponding to the type of the live streaming scenario is enabled in response to the second reservation option being in the selected state; and
outputting the prompt information in response to a live streaming activity associated with the resource sub-package corresponding to the type of the live streaming scenario being started.

9. An electronic device, comprising: a processor; and a memory storing one or more instructions executable by the processor; wherein the processor, when loading and executing the one or more instructions, is caused to:
display, in response to a trigger operation for acquiring a virtual resource package, the virtual resource package receivable by a user account and a reservation option, wherein the virtual resource package includes a predetermined number of virtual resources, and the reservation option is configured to reserve activities that allow use of the virtual resource package, and is switchable between a selected state and an unselected state, and an activity prompter for the virtual resource package is enabled in response to the reservation option being in the selected state; and
output prompt information in response to the reservation option being in the selected state and a target activity being started, wherein the prompt information is configured to prompt the user account to use the virtual resource package, and the target activity is at least one of a plurality of activities that allow the use of the virtual resource package.

10. The electronic device according to claim 9, wherein the reservation option comprises at least one of a first reservation option displayed on a first page and a second reservation option displayed on a second page, wherein the first page is for receiving the virtual resource package, and the second page is for displaying detailed information of the virtual resource package.

11. The electronic device according to claim 10, wherein the reservation option comprises the first reservation option; and the processor, when loading and executing the one or more instructions, is caused to:
display a receiving entrance of the virtual resource package and the first reservation option on the first page, wherein the second page is displayed in response to the receiving entrance being triggered; and
update a state of the first reservation option to the selected state in response to a trigger operation on the first reservation option in the case that the first reservation option is in the unselected state.

12. The electronic device according to claim 11, wherein the processor, when loading and executing the one or more instructions, is caused to:
display the second page in response to a trigger operation on the receiving entrance, and display the target activity associated with the virtual resource package and the second reservation option on the second page, wherein the second reservation option is initially in the selected state in the case that the first reservation option is in the selected state prior to the trigger operation on the receiving entrance, and the second reservation option is initially in the unselected state in the case that the first reservation option is in the unselected state prior to the trigger operation on the receiving entrance.

13. The electronic device according to claim 12, wherein the processor, when loading and executing the one or more instructions, is caused to:
update a state of the second reservation option to the unselected state in response to a trigger operation on the second reservation option in the case that the second reservation option is in the selected state, and an activity prompter for the target activity associated with the virtual resource package is not enabled in response to the second reservation option being in the unselected state.

14. The electronic device according to claim 12, wherein the processor, when loading and executing the one or more instructions, is caused to:
display reservation prompt information for the virtual resource package in response to an exit operation on the second page in the case that the second reservation option is in the unselected state, wherein the reservation prompt information is configured to prompt the user account to enable an activity prompter for the target activity.

15. The electronic device according to claim 14, wherein the processor, when loading and executing the one or more instructions, is caused to:
update a state of the second reservation option to the selected state in response to a reservation determine operation on the reservation prompt information, and displaying an activity list, wherein the activity list comprises the target activity and a corresponding activity schedule, and the activity prompter for the target activity is enabled.

16. The electronic device according to claim 12, wherein the virtual resource package comprises a plurality of resource sub-packages; and the processor, when loading and executing the one or more instructions, is caused to:
determine types of usage scenarios corresponding to the plurality of resource sub-packages;
display the plurality of resource sub-packages, the types of the usage scenarios corresponding to the plurality of resource sub-packages, and the second reservation option on the second page, wherein the second reservation option corresponds to a target usage scenario, a type of the target usage scenario comprises a type of a live streaming scenario, and an activity prompter for the resource sub-package corresponding to the type of the live streaming scenario is enabled in response to the second reservation option being in the selected state; and
output the prompt information in response to a live streaming activity associated with the resource sub-package corresponding to the type of the live streaming scenario being started.

17. A computer-readable storage medium storing one or more instructions therein, wherein the one or more instructions, when loaded and executed by a processor of an electronic device, cause the electronic device to:
display, in response to a trigger operation for acquiring a virtual resource package, the virtual resource package receivable by a user account and a reservation option, wherein the virtual resource package includes a predetermined number of virtual resources, and the reservation option is configured to reserve activities that allow use of the virtual resource package, and is switchable between a selected state and an unselected state, and an activity prompter for the virtual resource package is enabled in response to the reservation option being in the selected state; and
output prompt information in response to the reservation option being in the selected state and a target activity being started, wherein the prompt information is configured to prompt the user account to use the virtual resource package, and the target activity is at least one of a plurality of activities that allow the use of the virtual resource package.
